(19) United States
(12) Patent Application Publication
(10) Pub. No.: US 2007/0187911 A1
(43) Pub. Date: Aug. 16, 2007

(54) Revolution snowboard binding rotation and riser system

(76) Inventor: Jonathan D. Morley, Bainbridge Island, WA (US)

Correspondence Address: JONATHAN D. MORLEY, 8154 NE BECK ROAD, BAINBRIDGE ISLAND, WA, 98110, US

(21) Appl. No.: 11/643,555

(22) Filed: Dec. 21, 2006

Related U.S. Application Data
(60) Provisional application No. 60/752,531, filed on Dec. 21, 2005.

(51) Int. Cl. B62B 15/00

(52) U.S. Cl. 280/14.24

(57) ABSTRACT

The Revolution Snowboard Binding Rotation & Riser System (RSBRRS) creates an interface between snowboard and binding enabling a user to adjust rotation angle of the binding. It is designed to be compatible with all types of boards, normal boot sizes, bindings, stances and adjusts quickly while stationary or in motion. The RSBRRS is comprised of several parts; fixed base plate (FIGS. 7A-G), top rotation plate (FIGS. 6A-G), hinged release lever (FIGS. 8A-G), toe/heel supports (FIGS. 10A-G), fixed ‘dummy’ riser plate (FIGS. 9A-G) and associated hardware for each piece (FIGS. 2, 3, 4). Activating the release lever and rotating the binding, a rider can adjust to preferred stance thus relieving twisting pressure on the knee. This ability to rotate parallel to the direction of travel eliminates the knee twisting, but also has the added benefit of allowing the board to fit neatly on the footrests while seated on chairlift.

### CROSS REFERENCE TO RELATED APPLICATIONS

This application claims the benefit of U.S. Provisional Patent Application No. 60/752,531 filed Dec. 21, 2005.

### BACKGROUND OF THE INVENTION

While engaging in the act of snowboarding (aka: riding or boarding) both feet are secured to the board via boots and fixed bindings and the feet are generally positioned between 0 to 90-degrees to the direction of travel. When at rest or moving slowly (e.g. when in chairlift lines, during a traverse of flat slopes, etc.) typically the rider's leading foot remains attached to the board, but the trailing foot is released from the binding to help push the snowboard forward similar to the way a skateboard is propelled forward. One of the biggest sources of discomfort for a snowboarder is experienced during those instances when only one foot is secured to the bindings which results and the knee is in a twisted position. If that twisting could quickly be eliminated, it would relieve the stress of twisting on the knee and in many instances eliminate lost momentum and the need to unfasten both feet from the bindings, forcing the rider to walk.

### BRIEF SUMMARY OF THE INVENTION

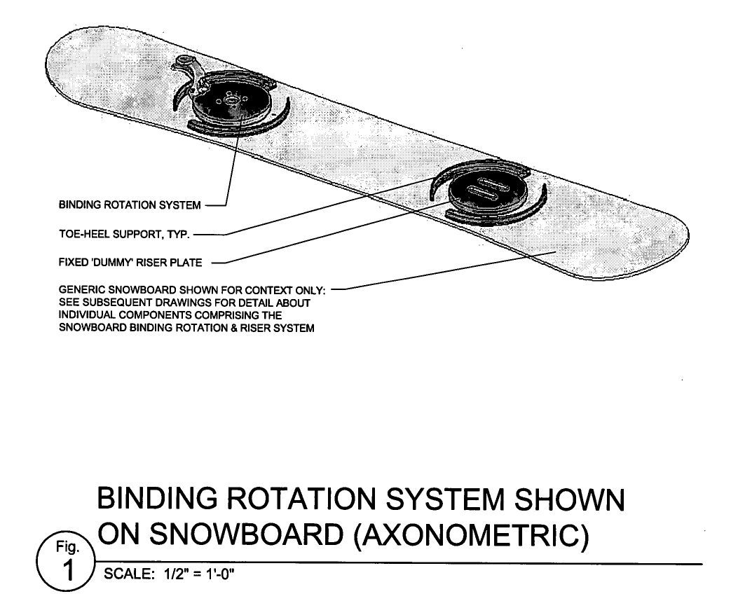

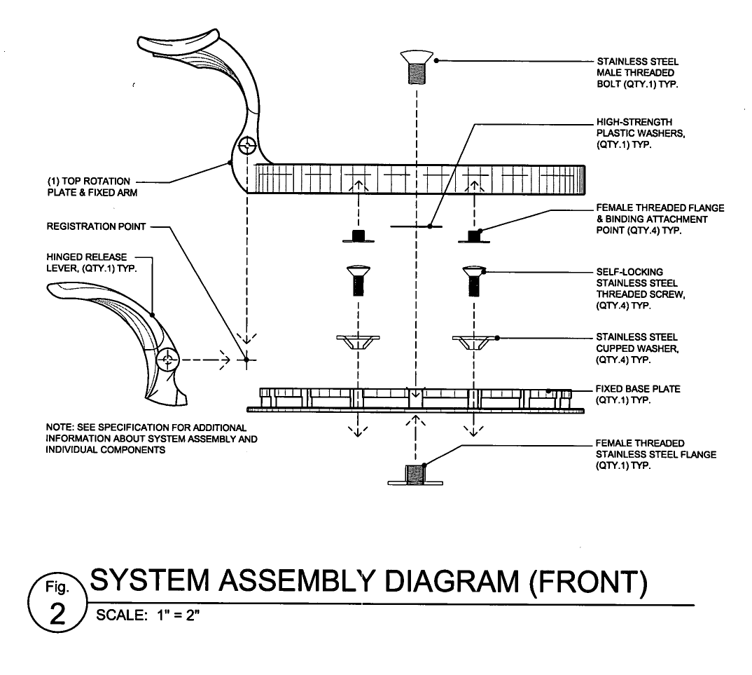

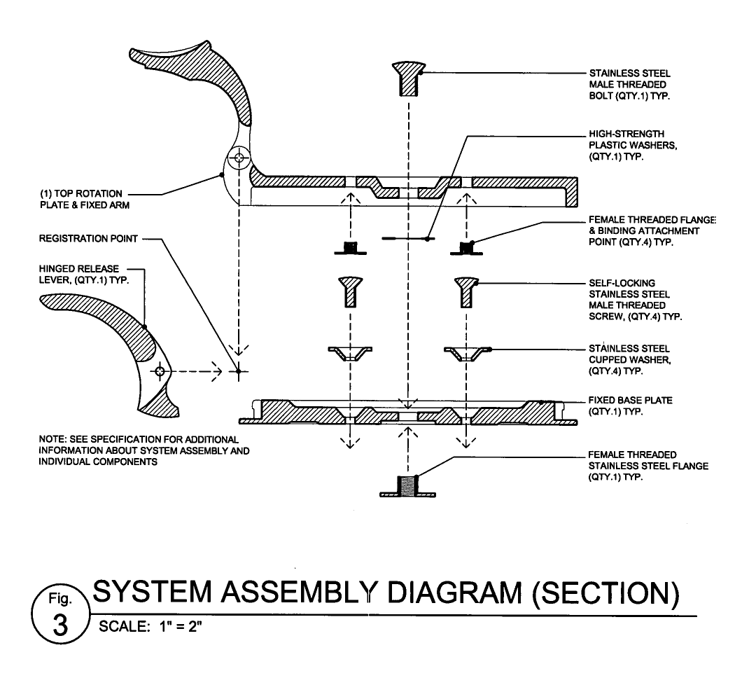

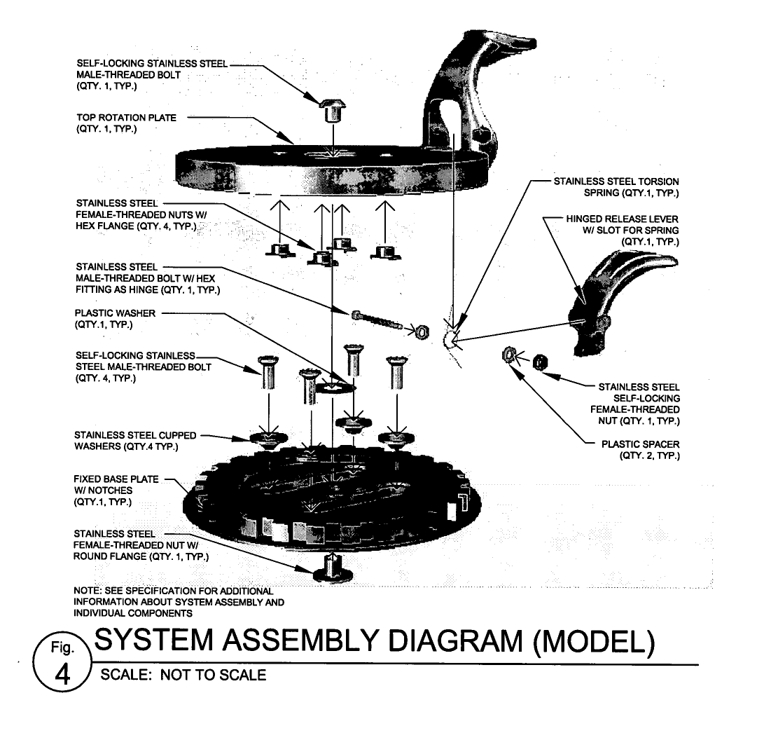

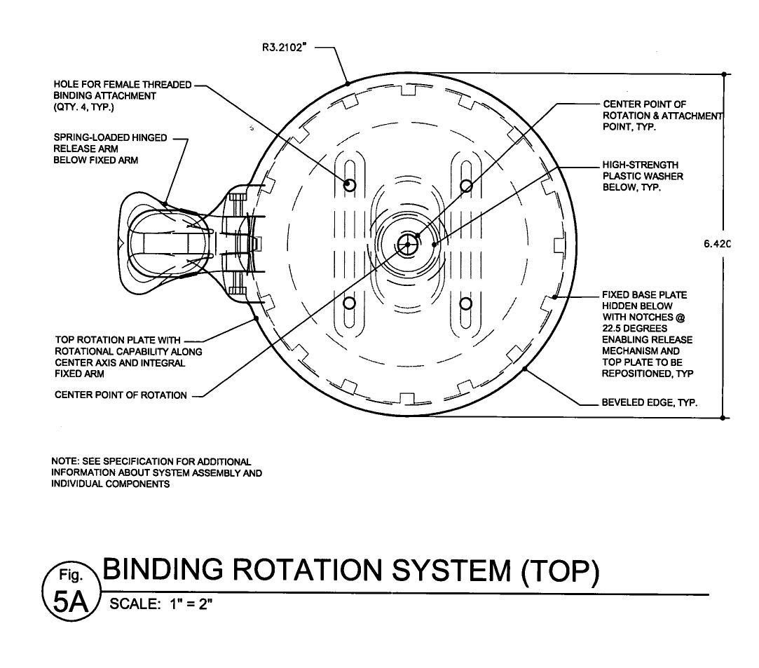

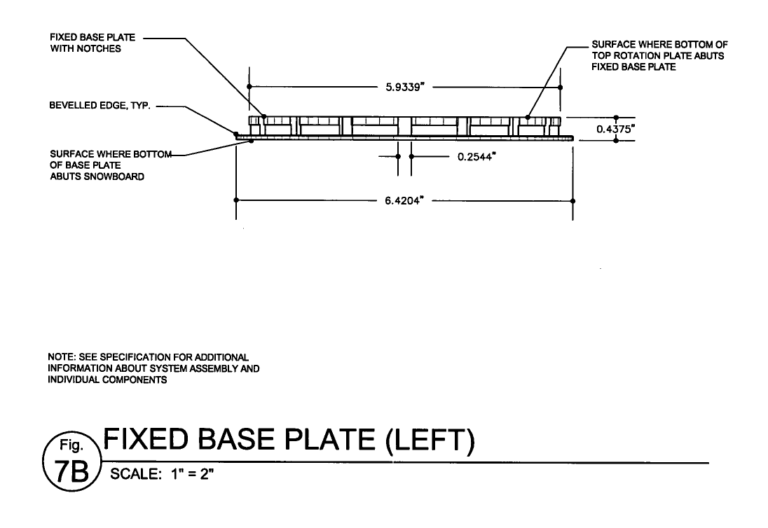

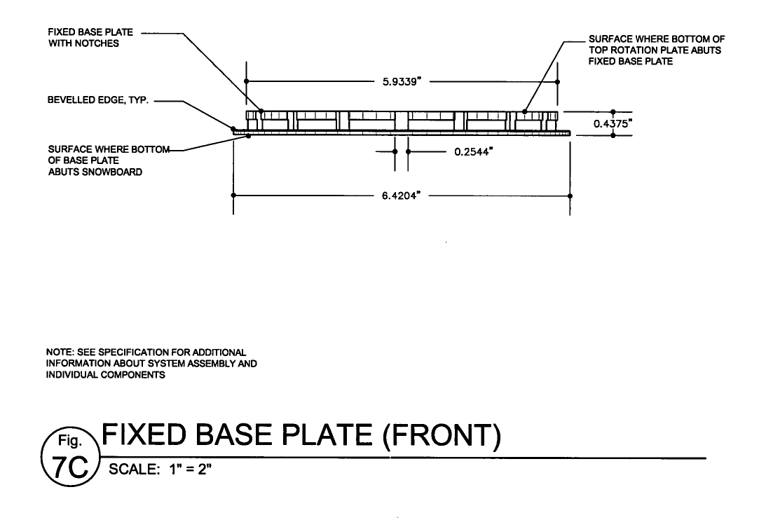

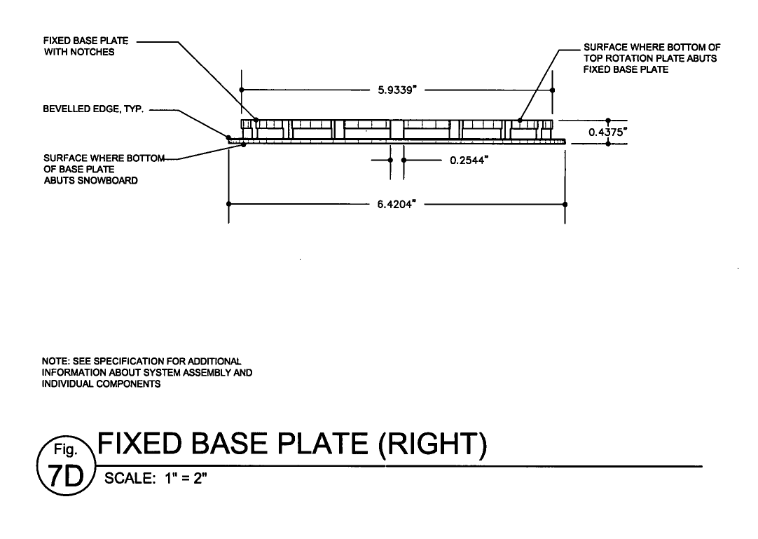

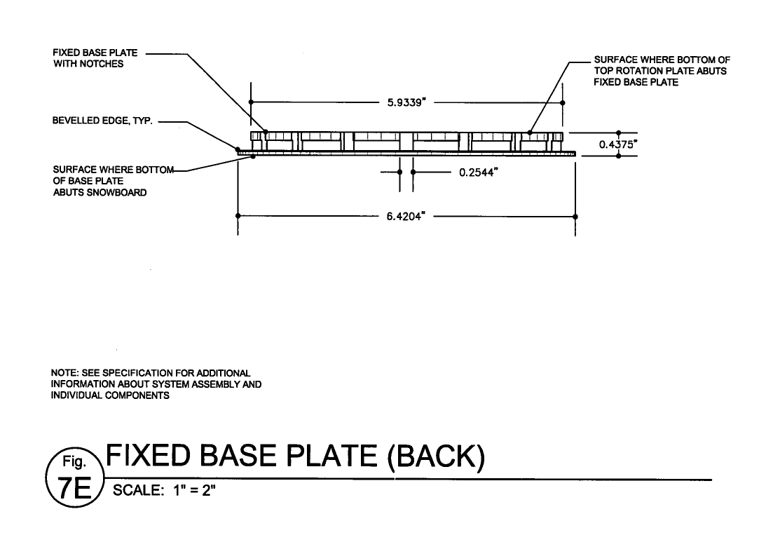

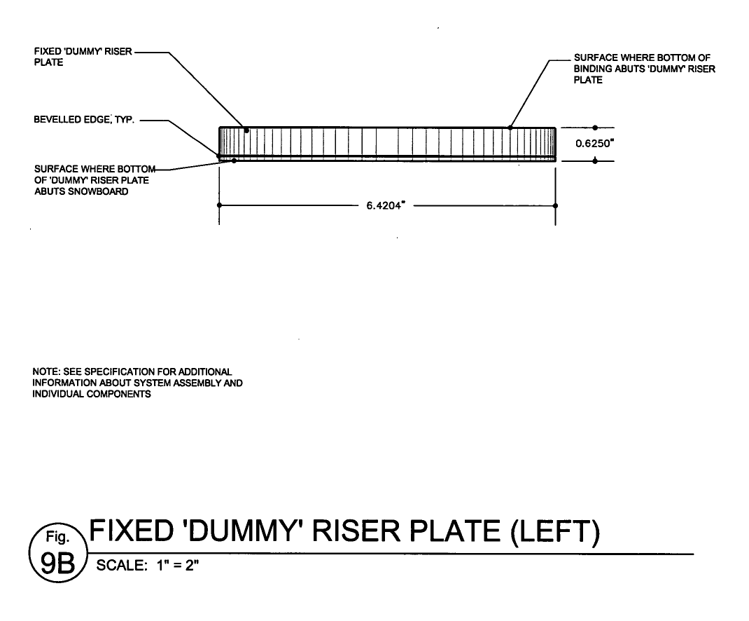

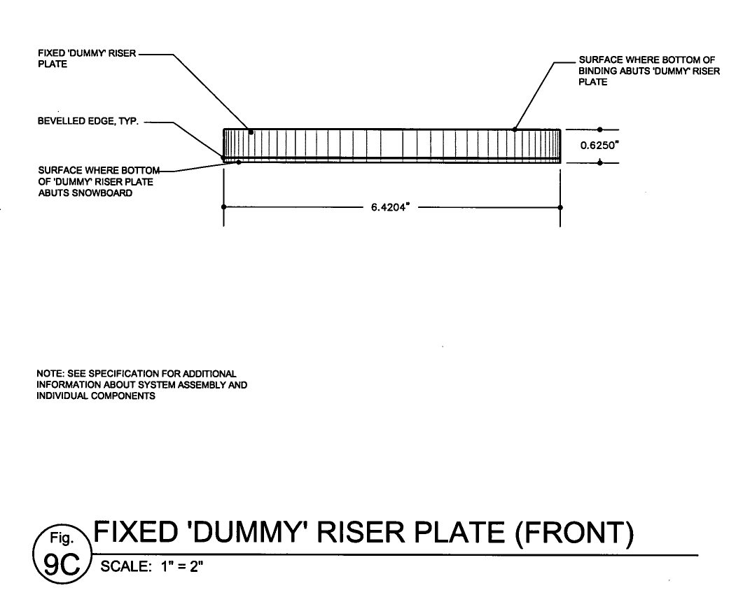

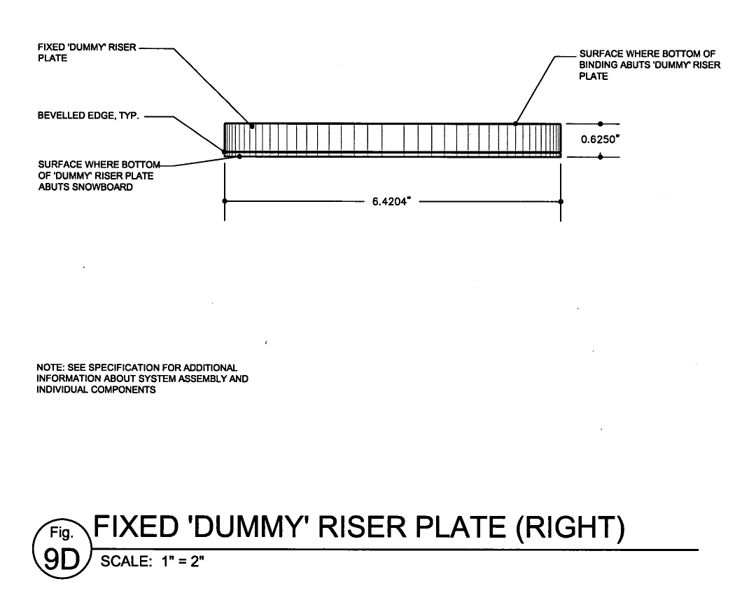

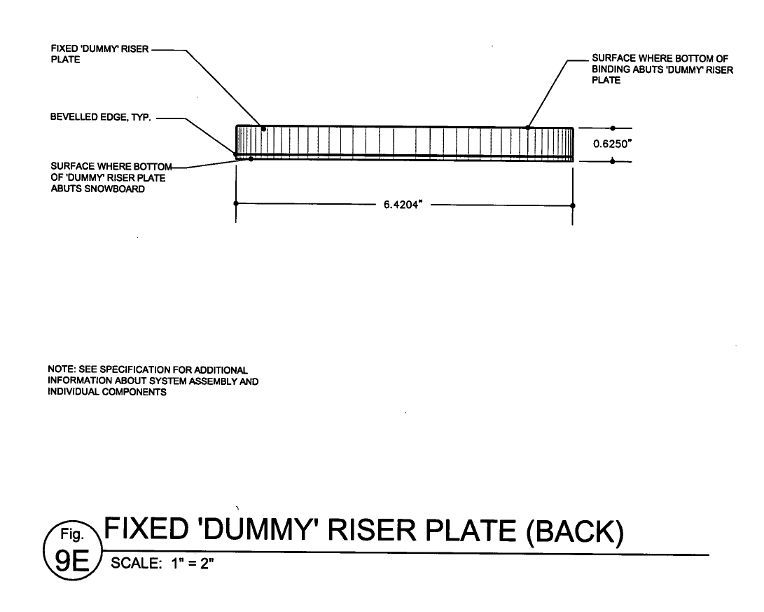

The Revolution Snowboard Binding Rotation & Riser System (RSBRRS) creates an interface between snowboard and binding enabling a user to quickly adjust the rotation of their binding relative to the board. It is positioned directly between the top of the snowboard and the bottom of each snowboard binding. The RSBRRS (FIG. 1) is lightweight, low profile, designed to be compatible with all types of boards, bindings, stances and takes a moment to adjust while stationary or in motion. By activating the hinged release lever (FIGS. 5A-G, FIGS. 8A-G) and rotating the binding, a rider can adjust to their preferred stance thus relieving pressure on the knee. This ability to rotate towards, or parallel to, the direction of travel not only eliminates the knee twisting, but also has the added benefit of allowing the board to fit neatly on the footrests while seated on a chairlift versus angling across other skier/boarder's space.

### DESCRIPTION OF VIEWS OF THE DRAWINGS

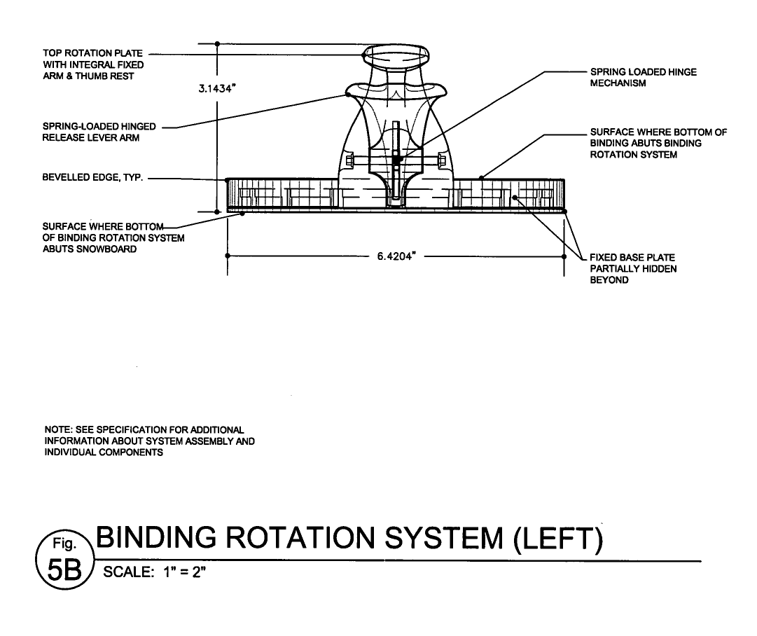

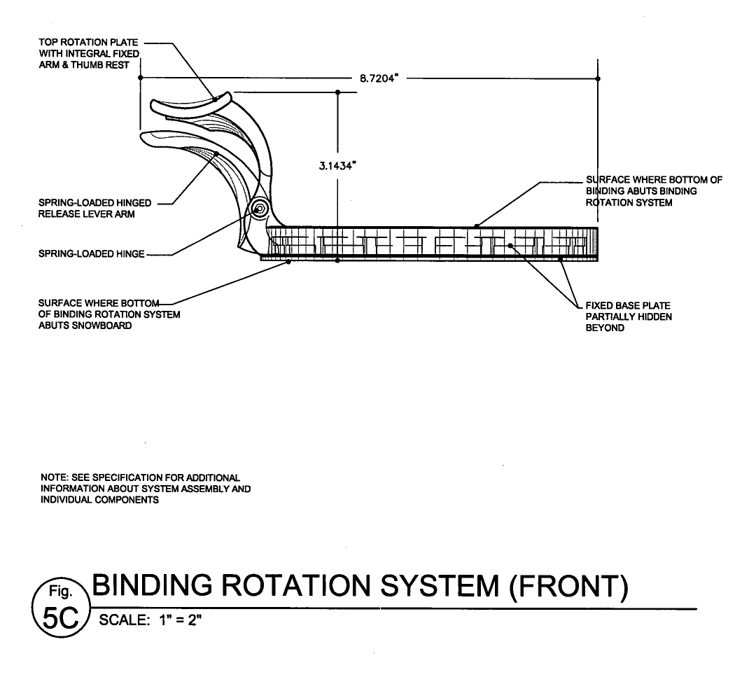

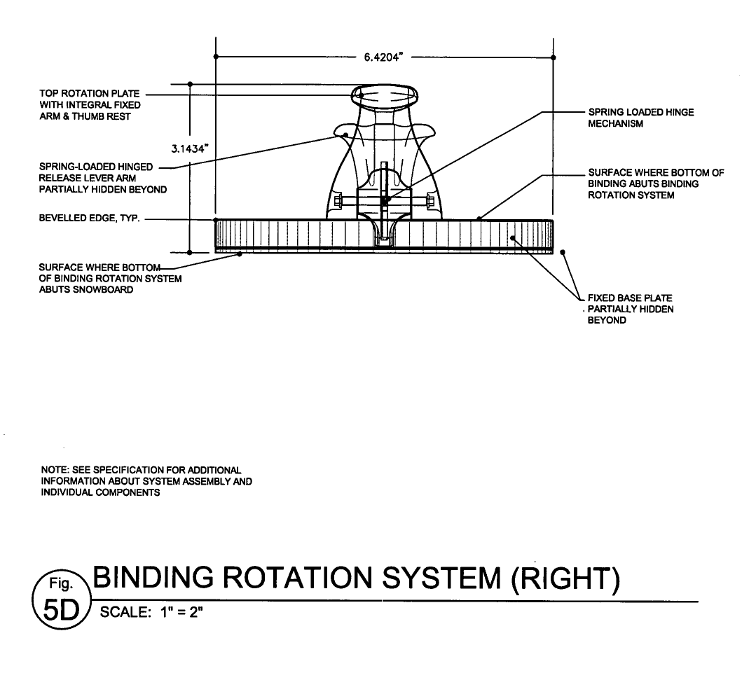

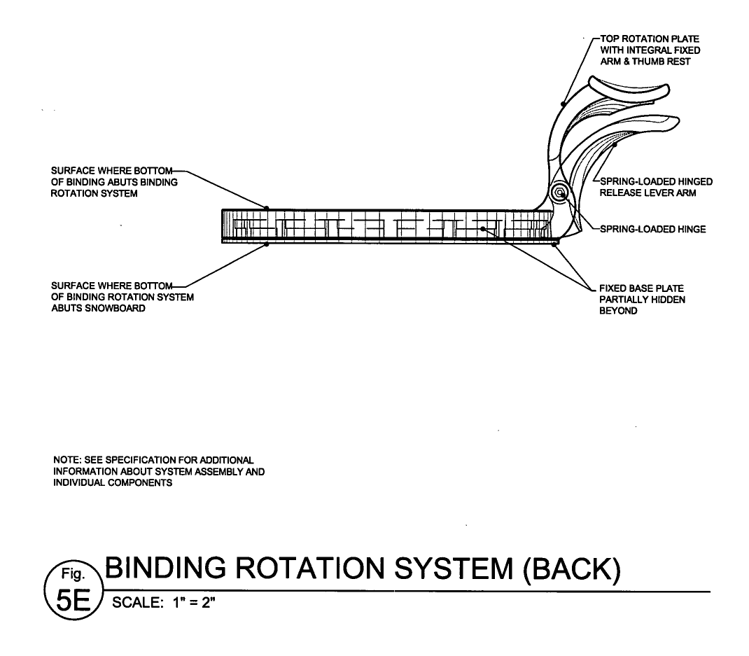

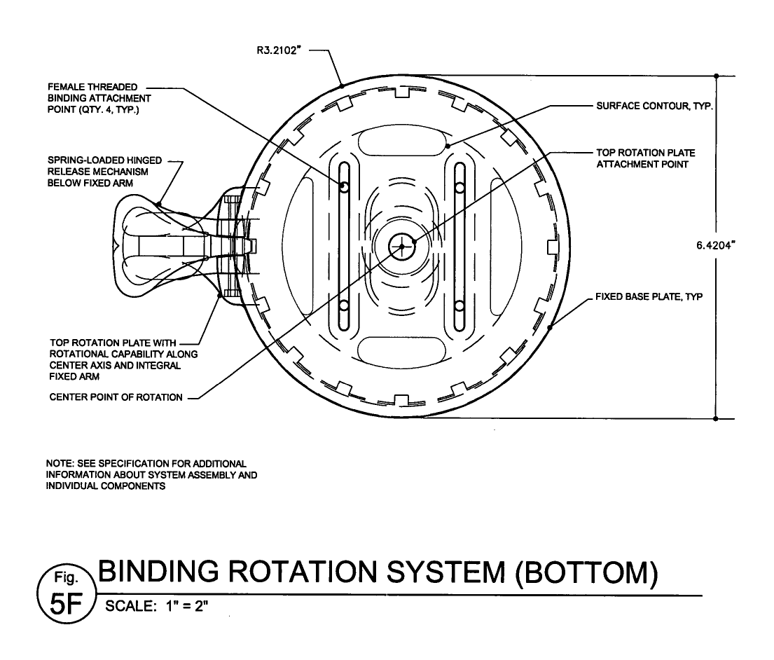

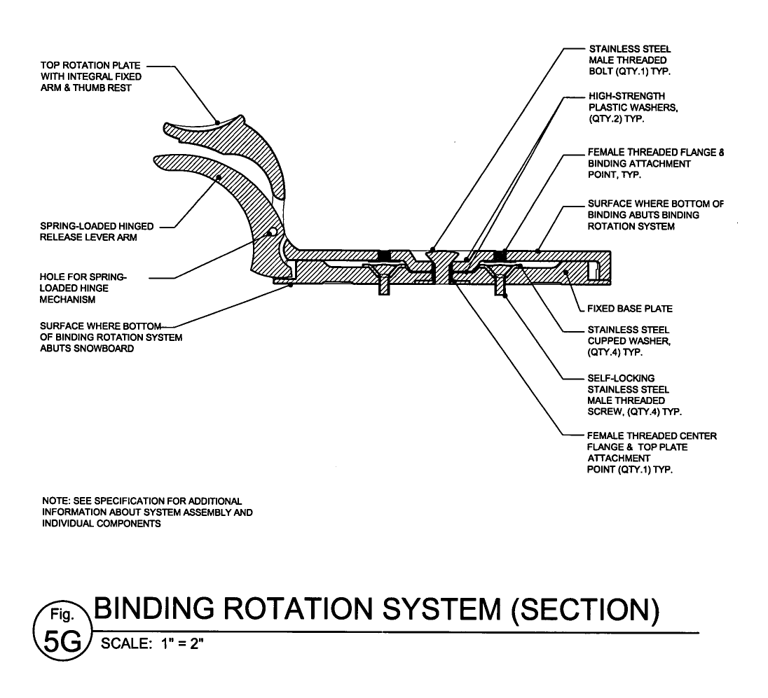

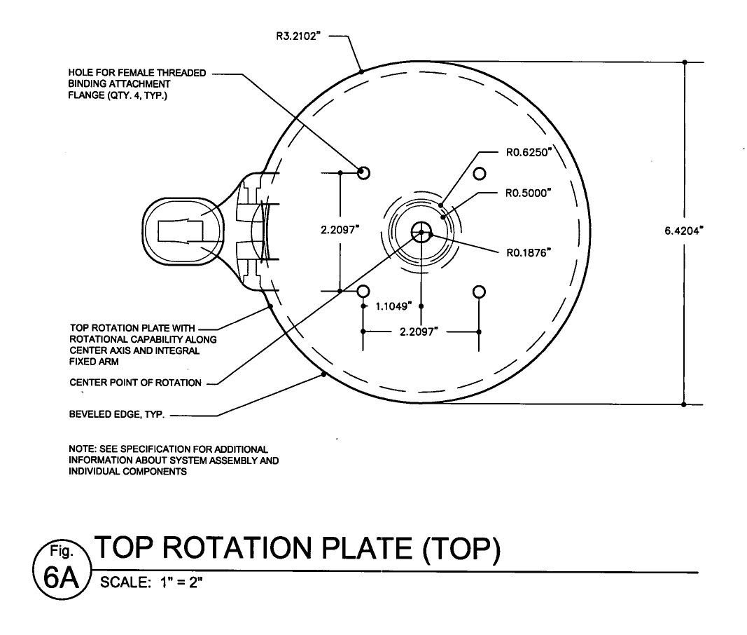

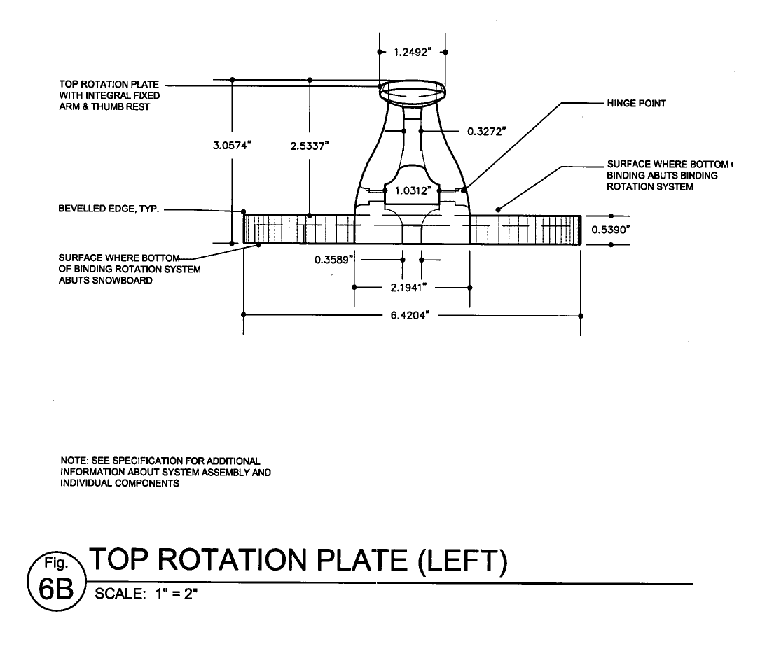

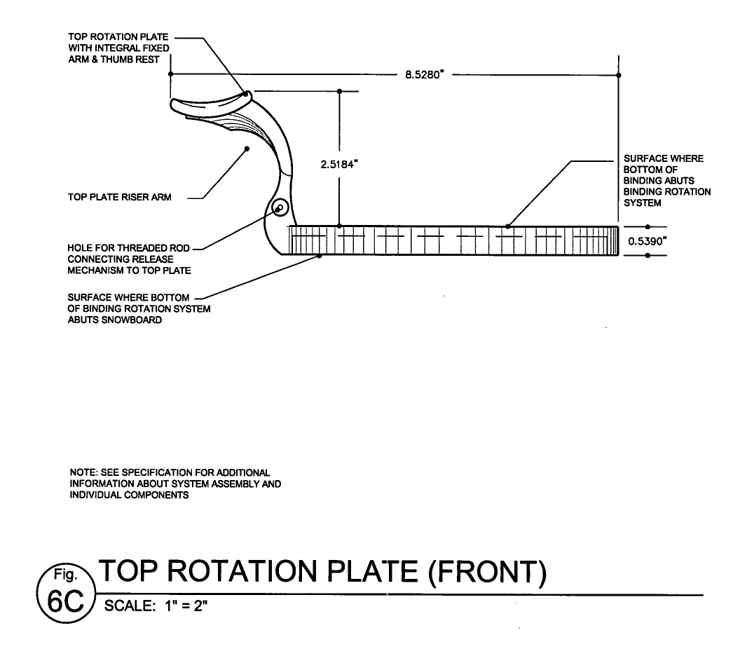

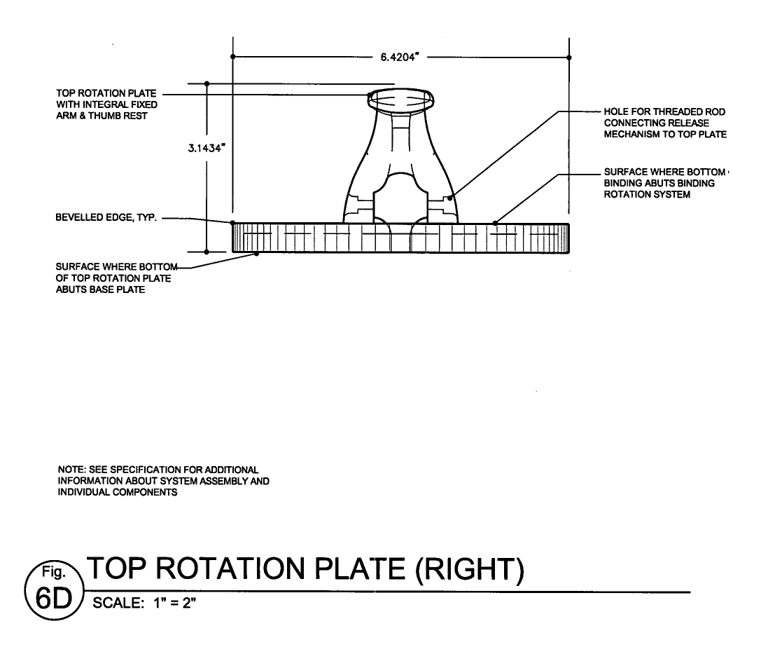

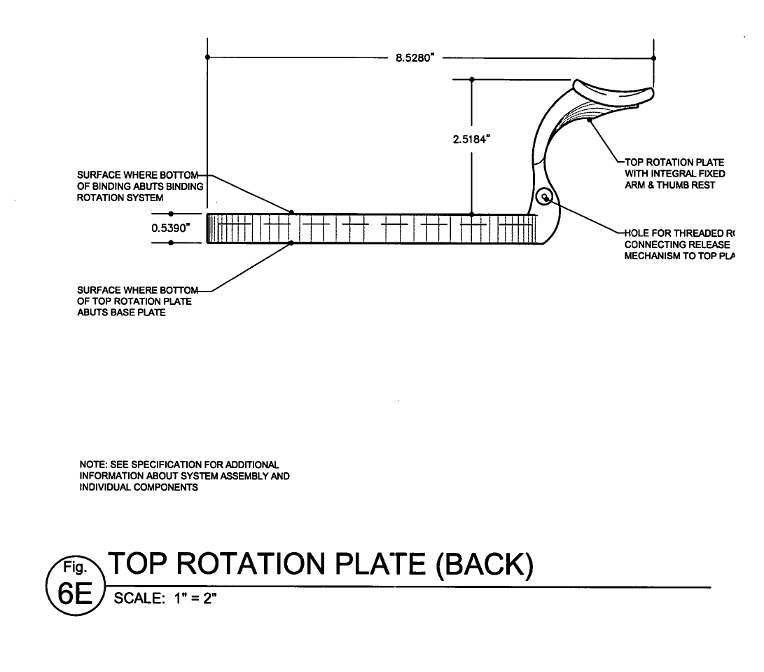

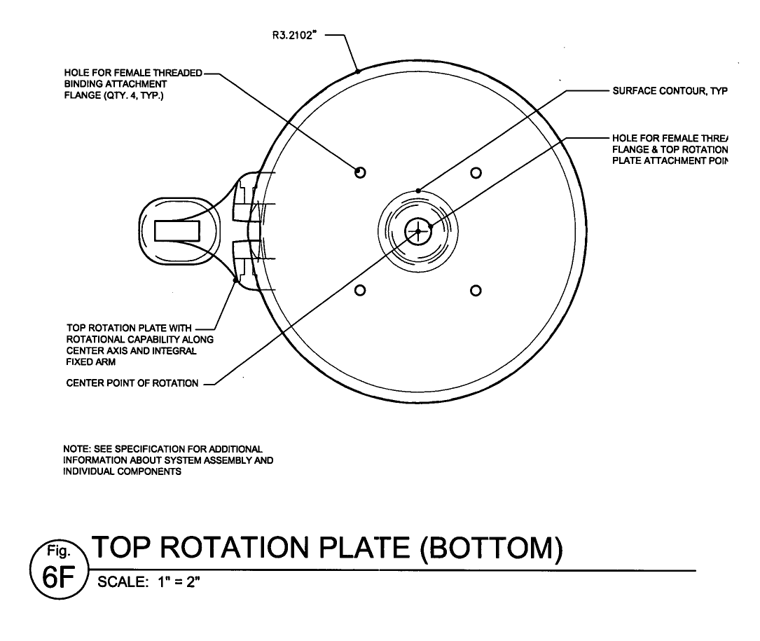

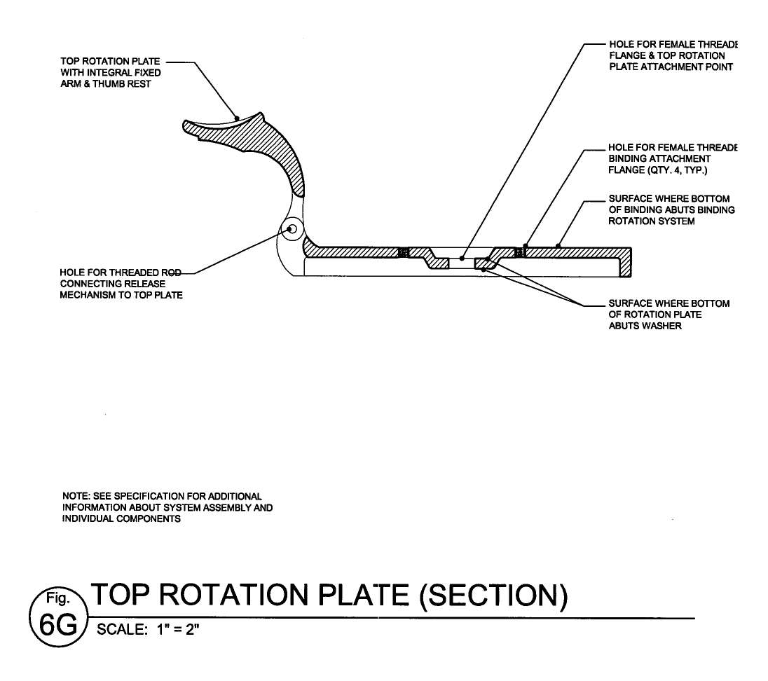

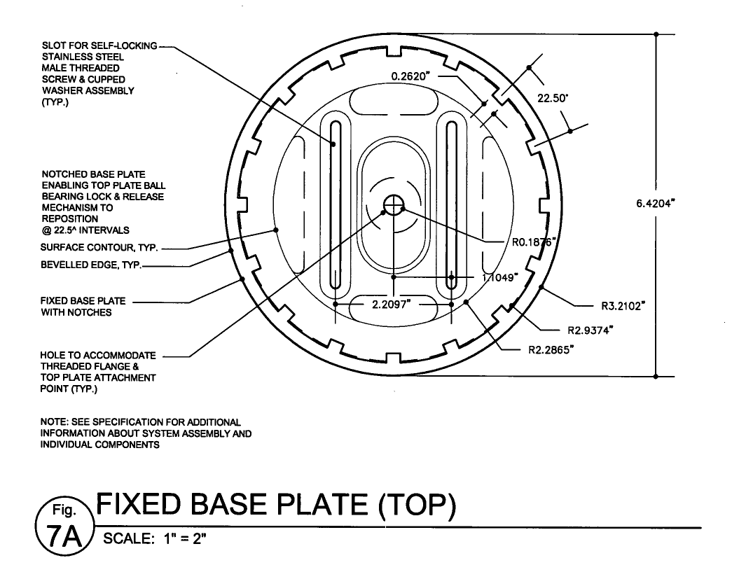

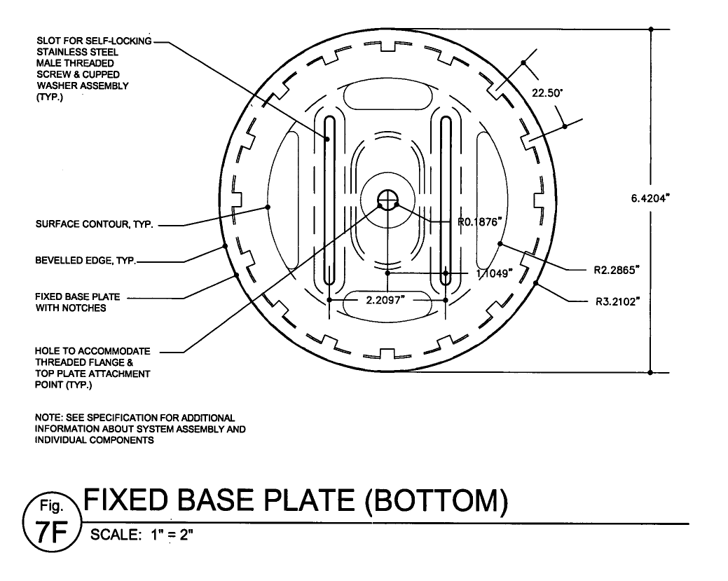

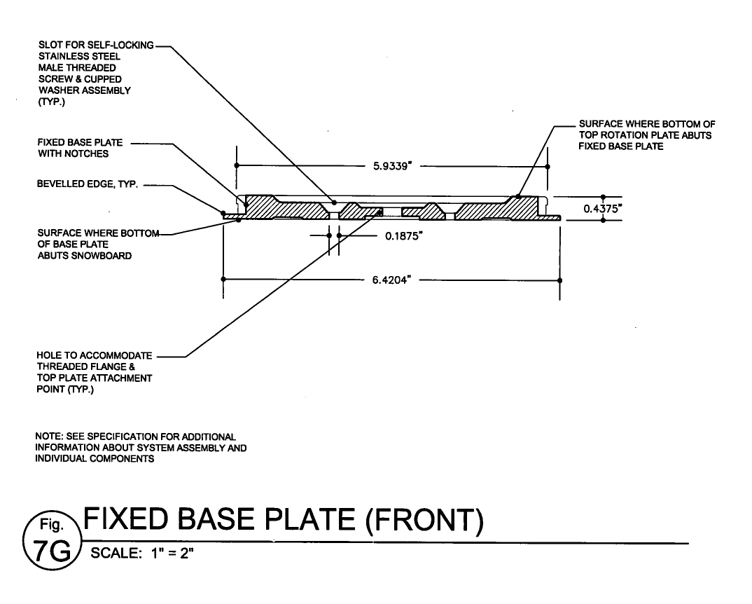

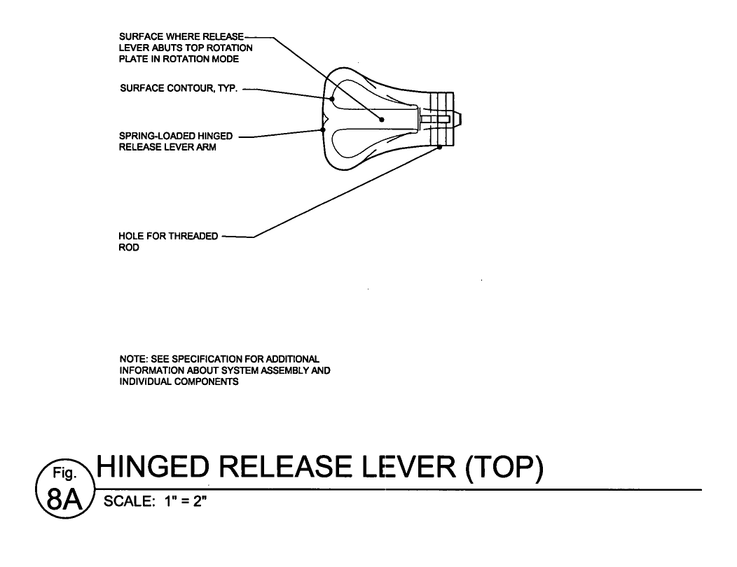

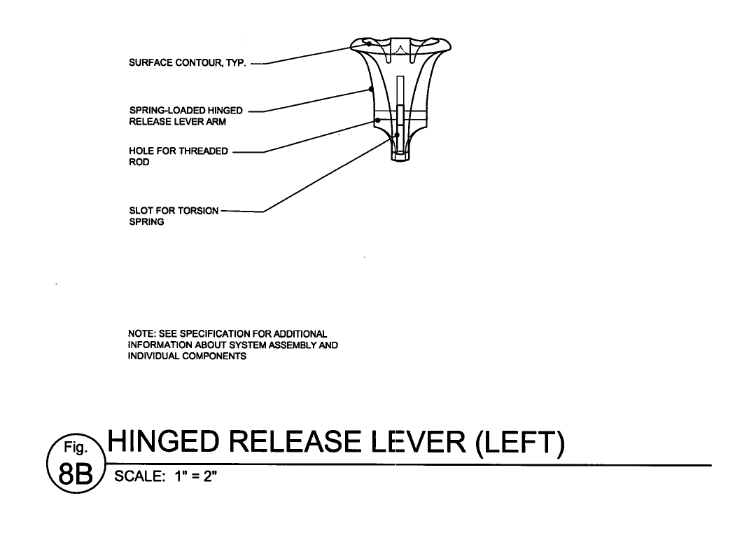

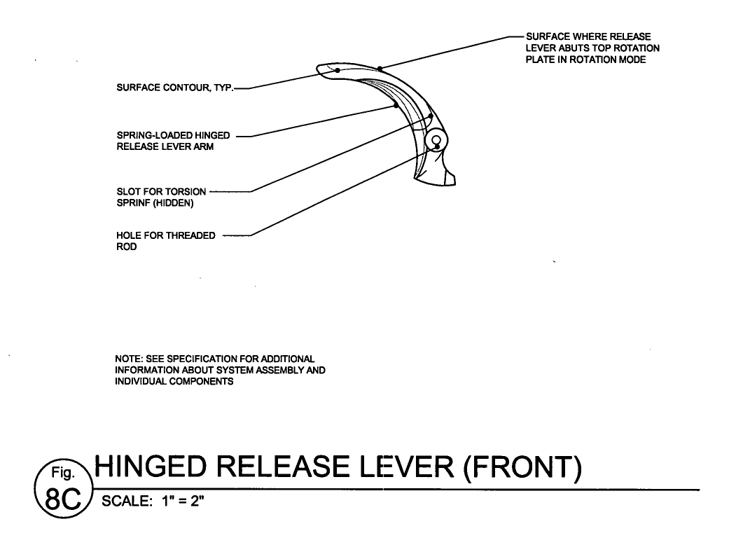

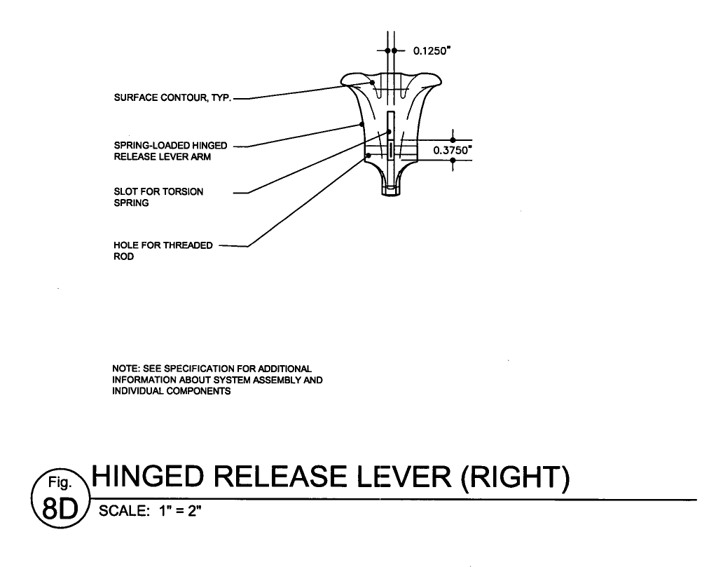

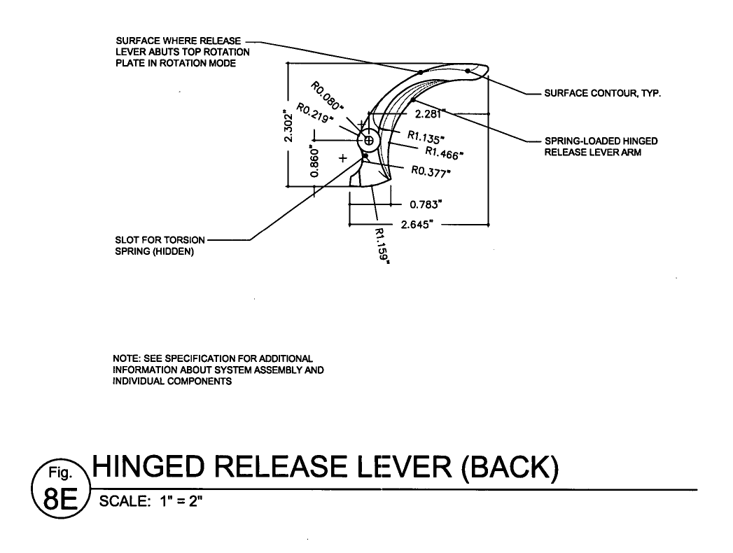

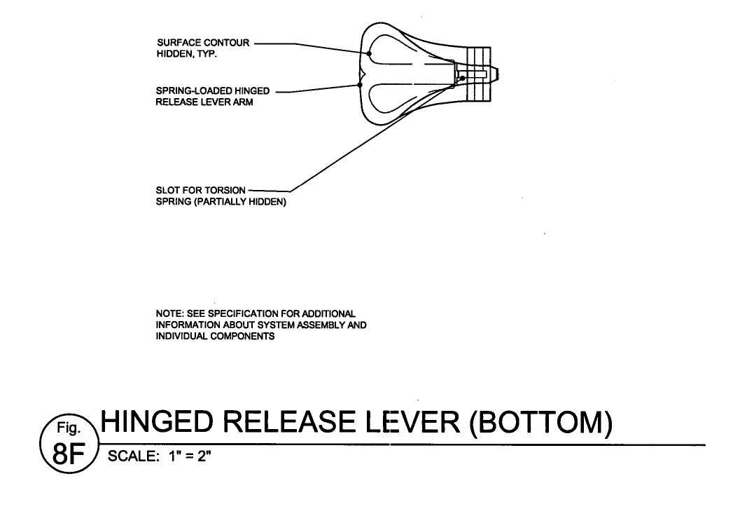

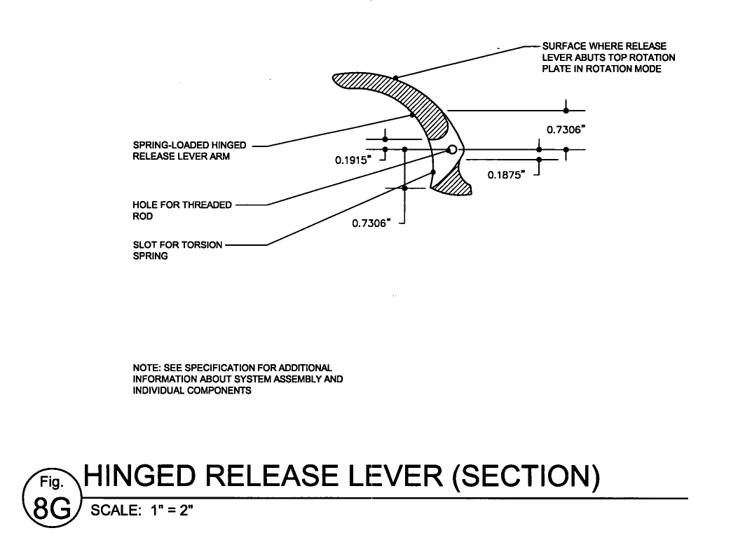

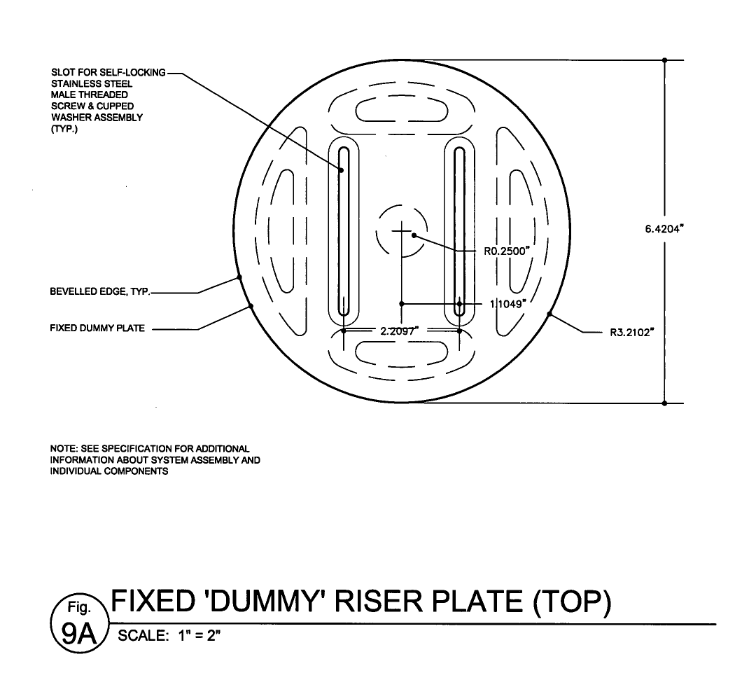

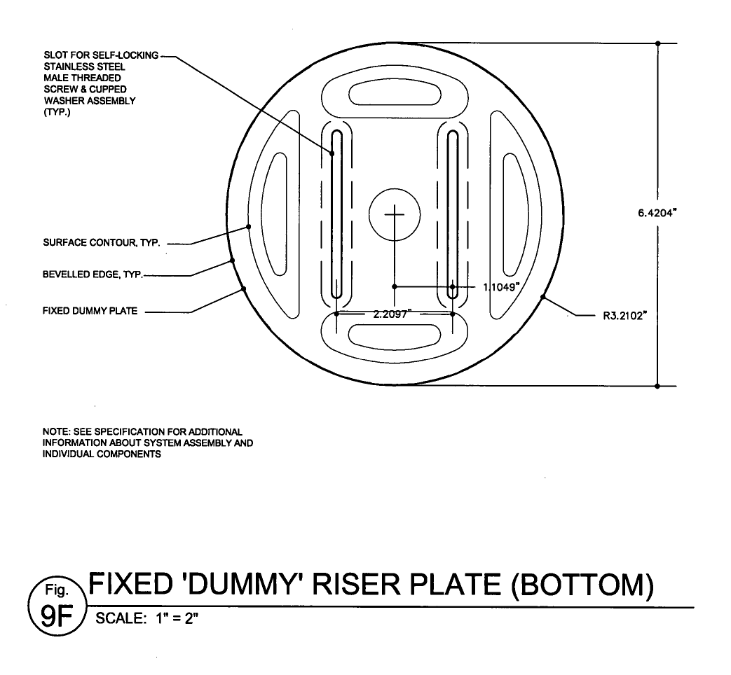

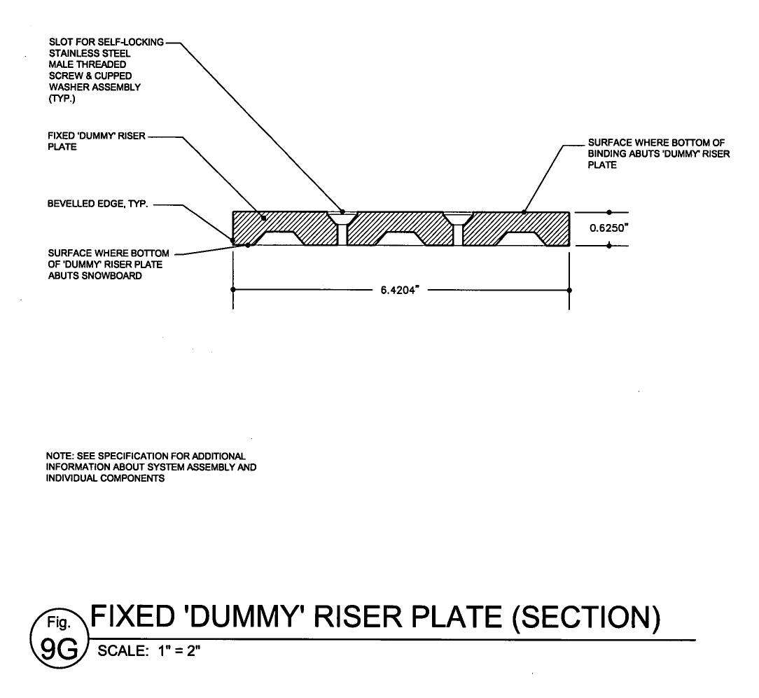

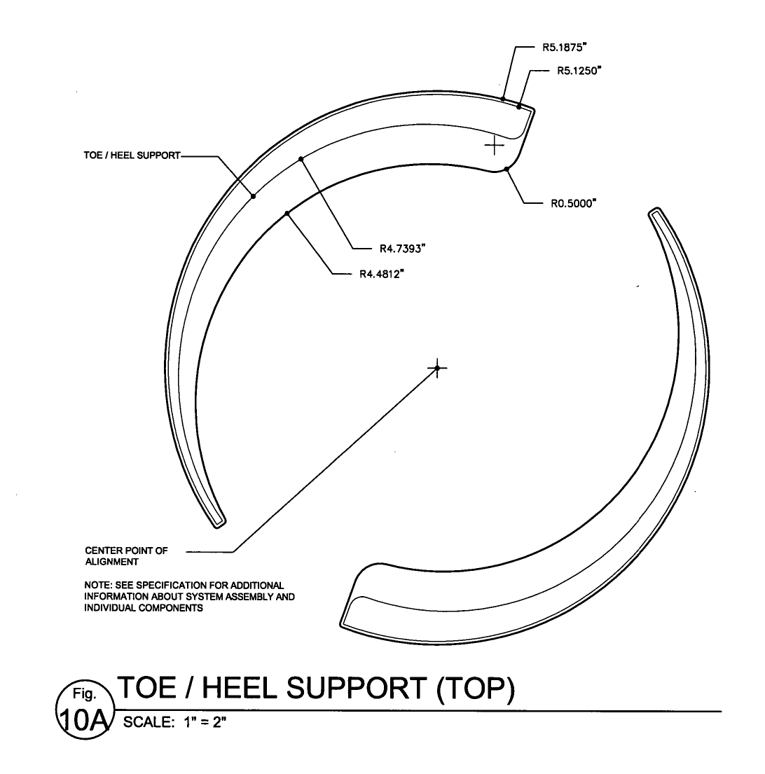

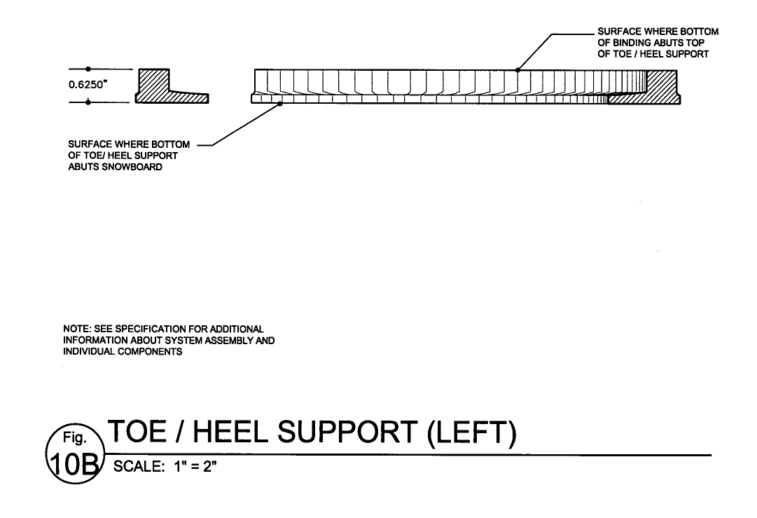

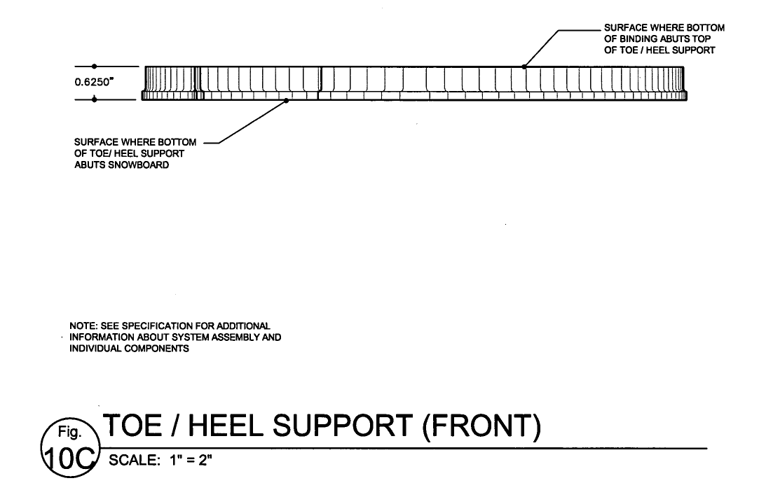

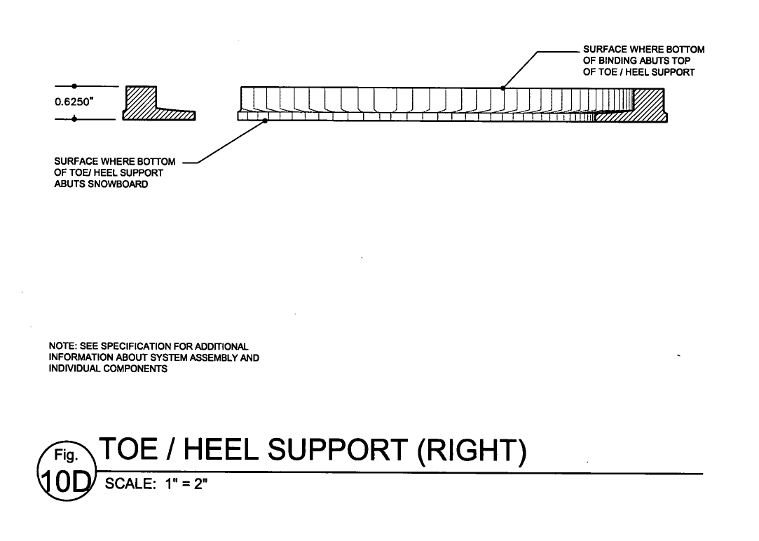

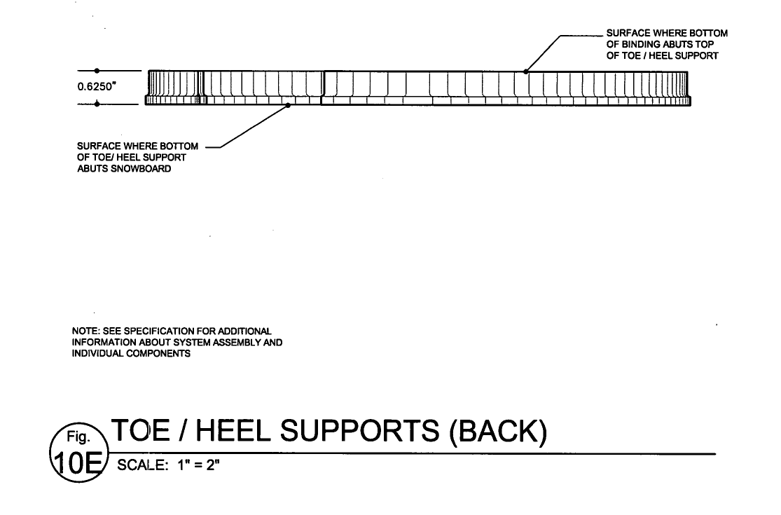

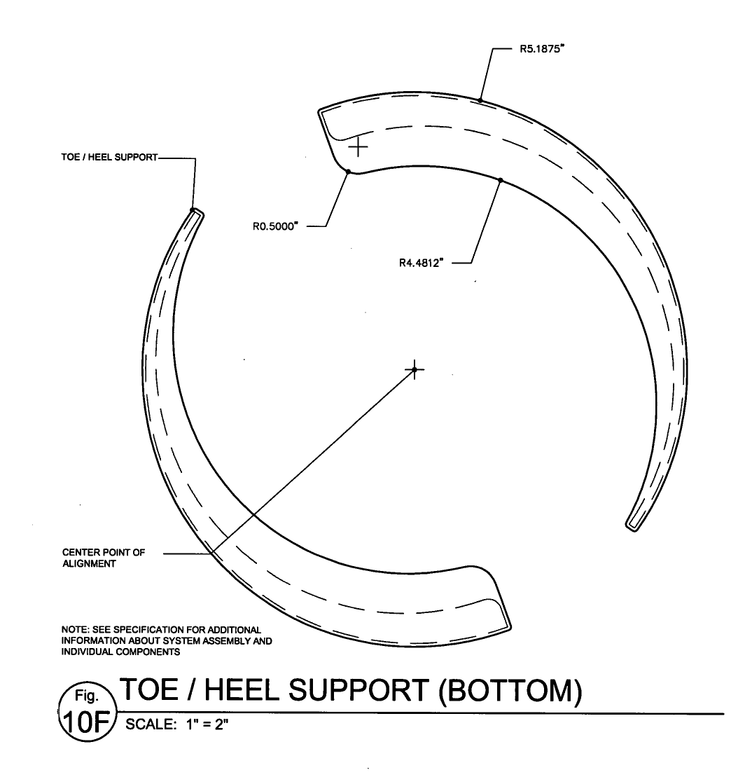

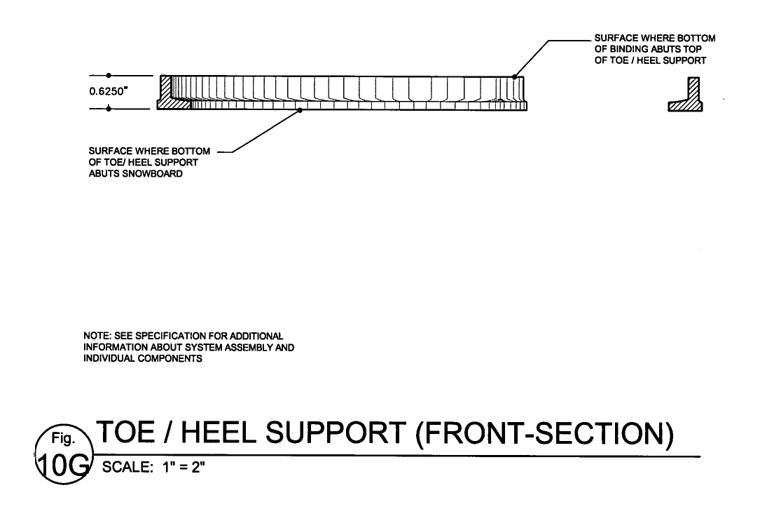

The RSBRRS is positioned directly between the top of the board and the bottom of the binding and comprised of several major parts; a fixed base plate (FIGS. 7A-G), a top rotation plate (FIGS. 6A-G), a hinged release lever (FIGS. 8A-G), toe/heel supports (FIGS. 10A-G), a ‘dummy’ riser plate (FIGS. 9A-G) and associated attachment hardware for each piece (FIG. 2, FIG. 3, FIG. 4). Below is a description of the Views of the Drawings as well as a brief description of the individual parts as applicable:

### FIG. #DRAWING TITLE/DESCRIPTION:

1. Binding Rotation System Shown on Snowboard (Axonometric)
2. System Assembly Diagram (Front)
3. System Assembly Diagram (Section)
4. System Assembly Diagram (Model)
5A. Binding Rotation System (Top)
5B. Binding Rotation System (Left)
5C. Binding Rotation System (Front)
5D. Binding Rotation System (Right)
5E. Binding Rotation System (Back)
5F. Binding Rotation System (Bottom)
5G. Binding Rotation System (Section)
6A. Top Rotation Plate (Top): The top rotation plate fits over and aligns with the center point of the base plate. A threaded bolt slots through the top plate and connects with a female threaded flanged nut assembly securing it to the base plate. The top rotation plate also has a fixed riser with indentation for the user's thumb that becomes the mounting surface for the Release Mechanism (described below).
6B. Top Rotation Plate (Left)
6C. Top Rotation Plate (Front)
6D. Top Rotation Plate (Right)
6E. Top Rotation Plate (Back)
6F. Top Rotation Plate (Bottom)
6G. Top Rotation Plate (Section)
7A. Fixed Base Plate (Top): The base plate is a circular object, with notches every 22.5-degrees along the outer edge and four slots through the top that become the anchoring points. The plate gets attached directly to the topside of the snowboard via four (4) stainless steel, self-locking screw/cupped washer assemblies like those universally used in the industry for securing bindings to snowboards. The base plate shall be fixed and does not move.
7B. Fixed Base Plate (Left)
7C. Fixed Base Plate (Front)
7D. Fixed Base Plate (Right)
7E. Fixed Base Plate (Back)
7F. Fixed Base Plate (Bottom)
7G. Fixed Base Plate (Section)
8A. Hinged Release Lever (Top): The hinged release mechanism gets connected directly to the riser of the top rotation plate via a stainless steel threaded rod and consists of a flared surface fitted to the user's fingers and vertical slot for affixing a torsion spring.
8B. Hinged Release Lever (Left)
8C. Hinged Release Lever (Front
8D. Hinged Release Lever (Right)
8E. Hinged Release Lever (Back)
8F. Hinged Release Lever (Bottom)
8G. Hinged Release Lever (Section)
9A. Fixed ‘Dummy’ Riser Plate (Top): The fixed ‘Dummy’ Rise Plate is a circular object with four slots through the top that become the anchoring points. The plate gets attached directly to the topside of the snowboard via four (4) stainless steel, self-locking screw/cupped washer assemblies like those universally used in the industry for securing bindings to snowboards. The base plate shall be fixed and does not move. The ‘Dummy’ Plate is an optional piece of equipment and is only needed if a rider opts for one Binding Rotation System under one foot, and the ‘Dummy’ Plate elevates the other binding above the snowboard to is a consistent height as the binding rotation system.
9B. Fixed ‘Dummy’ Riser Plate (Left)
9C. Fixed ‘Dummy’ Riser Plate (Front)
9D. Fixed ‘Dummy’ Riser Plate (Right)
9E. Fixed ‘Dummy’ Riser Plate (Back)
9F. Fixed ‘Dummy’ Riser Plate (Bottom)
9G. Fixed ‘Dummy’ Riser Plate (Section)
10A. Toe/Heel Support (Top): The toe/heel supports are made of lightweight, high-strength plastic with an adhesive bottom. Two (2) of these are required per binding (left and right) and shall be positioned in a radial fashion around the rotation plate to provide support, regardless of degree of rotation of the user's binding. The toe/heel supports shall be affixed to the snowboard after the rotation plate is secured to the snowboard and prior to the securing the binding to the RSBRRS.
10B. Toe/Heel Support (Left)
10C. Toe/Heel Support (Front)
10D. Toe/Heel Support (Right)
10E. Toe/Heel Support (Back)
10F. Toe/Heel Support (Bottom)
10G. Toe/Heel Support (Front-Section)

### BEST MANNER OF USING THE INVENTION

Prior to using the RSBRRS a few standard steps must be taken: the RSBRRS shall be secured to the snowboard with four (4) stainless steel, self-locking screws exactly like those universally used in the industry for securing bindings to snowboards; the user's choice of binding shall be secured to the RSBRRS with four (4) stainless steel, self-locking screws provided by the manufacturer of binding being used; the user's feet shall be laced securely into their boots and the boots shall be set in their bindings securely per the binding manufacturer's recommendations. Once these preliminary steps are complete, the device is ready for use.
1. By placing the thumb on top of the fixed arm and the rest of the fingers below the hinged release lever (FIG. 8A-G) and squeezing, allowing the hinged release lever to dislodge from a slot in the fixed base plate (FIG. 7A-G), the RSBRRS becomes unlocked and free to rotate.
2. With the hinged release lever still in rotation-mode the user shall rotate the RSBRRS to one of sixteen (16)* desired positions. (*depending on the strength of materials used in manufacturing, the number of slots in the base plate could easily be increased, thereby increasing the number of positions).
3. Upon releasing the fingers, the mechanism locks into the fixed base plate (FIG. 7A-G) and ready for use in the new position.

There are several benefits to the user of the invention. The rotation of the binding system provides a variety of benefits that result in higher performance on the slopes and significantly increased comfort in the lift line or while traversing. One of the biggest sources of discomfort for a snowboarder is experienced while in lift lines or during a traverse when only one foot is secured to the bindings and the knee is in a twisted position. Since typically the boarder's leading foot remains attached to the board, the RSBRRS allows the boarder to activate the release mechanism and rotate the binding to their preferred stance thus relieving pressure on the knee. This ability to rotate towards the direction of travel not only eliminates the knee twisting, but also allows the board to fit neatly on the footrests while seated on a chairlift versus angling across other skier/boarder's space. The thickness of the RSBRRS elevates the user's foot approximately ¾″ above the top of the board, which provides additional leverage while carving turns and translates into greater power, better control and quicker response when transitioning from edge to edge. Additionally, the RSBRRS elevates the foot above the board thereby minimizing the toe and/or heel drag often experienced by riders with larger feet.

The materials and process for fabrication are flexible. Most of the components comprising the RSBRRS can be constructed from several different types of lightweight materials such as machined aluminum, titanium, high-strength and/or reinforced plastic, carbon fiber composites or some combination of the above. This application does not seek to patent a specific material type or specific combination of materials, but instead patent the system (FIG. 2, FIG. 3, FIG. 4) and allow the manufacturer the freedom to select suitable materials based on availability, market prices and desired performance. That said, the male threaded screws and female threaded housing attachment points shall be constructed of high tensile strength stainless steel.

What is claimed in this application is:

1. I claim the Revolution Snowboard Binding Rotation & Riser System (RSBRRS), positioned directly between the top of the snowboard and the bottom of each snowboard binding, creates an interface between the two that enables a snowboarder (aka: rider or user) to quickly adjust the rotation of their binding relative to the board to any degree heading whether stationary or in motion.

2. I claim the RSBRRS provides the aforementioned capability within a lightweight, low-profile mechanism using only two moving parts and associated hardware.

3. I claim the RSBRRS is infinitely adjustable to suit any rider preference for angle of binding when the RSBRRS is in place and attached to the snowboard and binding.

4. I claim the RSBRRS has the ability to relieve twisting of a rider's knee when the trailing boot is released from its binding under normal snowboarding use at slow speeds, traversing flat slopes, in chairlift lines and while on the chairlift.

5. I claim the RSBRRS will accommodate all normal boot and binding sizes. The Toe-Heel Supports are designed to be used as part of the system when a boot and/or binding overhangs the Top Rotation Plate (FIG. 6A-G) and will accommodate normal to larger boot/binding sizes. If a rider has smaller boots/bindings, the RSBRRS can be used without the Toe-Heel Supports.

6. I claim the RSBRRS elevates both bindings above the snowboard thereby minimizing the toe and/or heel drag often experienced by riders with larger feet.

7. I claim the RSBRRS provides higher on-snow carving performance since the system elevates the binding assembly above the snowboard by approximately ¾″ and provides additional leverage for rider weight distribution and edge control.
